(19) United States
(12) Patent Application Publication
(10) Pub. No.: US 2025/0297131 A1
(43) Pub. Date: Sep. 25, 2025

(54) POTTING MATERIALS AND METHODS OF PRODUCING THEREOF

(71) Applicant: Applied Materials Israel Ltd., Rehovot (IL)

(72) Inventor: Denys Mets, Petah Tiqwa (IL)

(73) Assignee: Applied Materials Israel Ltd., Rehovot (IL)

(21) Appl. No.: 18/615,998

(22) Filed: Mar. 25, 2024

(51) Int. Cl. C09D 183/04; C08K 3/04; C08K 3/28; C08K 3/38; C09D 5/18; C09D 7/61

(52) U.S. Cl. CPC C09D 183/04; C09D 5/18; C09D 7/61; C08K 3/041; C08K 2003/282; C08K 2003/385; C08K 2201/001; C08K 2201/011; C08K 2201/014

(57) ABSTRACT

An insulating potting material for protecting electronic components in a high-voltage (HV) device, the potting material is characterized by a high effective dielectric strength and includes an elastomer, a cooling filler, and/or an electric field relaxer.

### TECHNICAL FIELD

The present disclosure relates generally to high-voltage (HV)-designated electronic devices. More particularly, the present disclosure relates to insulating potting materials for HV electronic devices, and to methods of producing thereof.

### BACKGROUND OF THE INVENTION

High-voltage (HV) devices such as transformers, converters, modulators, controllers, and power supplies, are crucial components in a range of applications. One such application is an electron microscopy (EM). In an EM machine, the reliability of the HV power supply is vital for producing high-resolution images. This power supply is required to operate the electrode of an electron beam.

The demand for high voltage (HV) machines that exhibit high resolution, controllability, reliability, and serviceability is growing. However, the reliability of devices that can withstand high voltage and support this demand is still low. Current state-of-the-art HV devices suffer from occasional discharges, which can lead to machine failure and/or disruption of high-resolution images. Interestingly, one of the main reasons for this lack of performance is the potting material. To perform well in HV devices, the potting material should integrate several critical properties such as high dielectric strength, high thermal conductivity, high adhesion, and low specific weight.

Therefore, there is a need for a high-performance potting material that will ensure the combination of all desired properties in a single composition.

### BRIEF SUMMARY OF THE INVENTION

This disclosure is directed, in accordance with some embodiments, to a reliable potting material for HV devices.

The potting material, in accordance with some embodiment, is configured to be characterized by high dielectric strength, high thermal conductivity, high adhesion, and low specific weight. As a result, and in accordance with some embodiments, encapsulation of HV devices using the high-performance potting material disclosed herein enhances the devices' performance, minimizes partial discharge incidences, and thus leads to more reliable HV devices.

An optimized formulation of potting material is provided herein, in accordance with some embodiments, and designed to hold said advantageous characteristics altogether. Additionally, methods for producing potting material and potted assemblies comprising said potting material formulation are provided.

There is provided herein, in accordance with some embodiments, an insulating potting material for protecting electronic components in a high-voltage (HV) device, the potting material including; an elastomer in a concentration of 50-100% (w/w); a cooling filler in a concentration of 5-70% (w/w); and/or an electric field relaxer in a concentration of 0.005-0.2% (w/w), said potting material is characterized by an effective dielectric strength of at least about 80% of its theoretical dielectric strength.

As used herein, according to some embodiments, the term “theoretical dielectric strength” is defined as a calculated weighted average, when considering the dielectric strength of the individual components of the potting material and their relative concentration in the whole potting material.

As used herein, according to some embodiments, the term “effective dielectric strength” is defined as the actual measured dielectric strength. In a partial discharge (PD) detector device, measurements are conducted by gradually applying a voltage that matches the “theoretical dielectric strength” of the potting material. The ratio of the observed voltage (prior to any discharge event) to the expected voltage is directly proportional to the ratio between the effective dielectric strength and the theoretical dielectric strength.

According to some embodiments, the partial discharge (PD) is less than about 10 mV, at a frequency of less than about 10 events over 2 min of 4 kV dc applied voltage.

According to some embodiments, the potting material is characterized by a thermal conductivity of at least about 0.2-3 W/m·k.

According to some embodiments, the potting material exhibits a specific weight of less than about 0.8-2.0 gr/cm³.

According to some embodiments, the elastomer includes phenol-formaldehyde polymer, epoxy resins, polyisoprene, butadiene polymer, styrene-butadiene copolymers, ethylenepropylene rubber (specifically EPDM), butyl and halobutyl elastomers, polyurethanes, polysiloxanes, polychloroprenes, nitrile rubber, polyacrylic rubbers, fluorocarbon elastomers, or any combination thereof.

According to some embodiments, the elastomer is polydimethylsiloxane (PDMS).

According to some embodiments, the elastomer is characterized by a dielectric strength of about 400-600 V/mil.

According to some embodiments, the elastomer has a specific weight of about 0.8-2.0 gr/cm³.

According to some embodiments, the elastomer originates from at least two pre-polymer parts, each having a physical state of liquid and/or semi-solid gel.

According to some embodiments, at least one of the at least two pre-polymer parts is characterized by a viscosity of about 300-4000 cP.

According to some embodiments, the at least two parts include monomer, crosslinker, polymer, pre-polymer, pre-preg, catalyst, solvent, or any combination thereof.

According to some embodiments, the elastomer is characterized by a thermal conductivity of at least about 0.1 W/m·K.

According to some embodiments, the cooling filler includes B—N, Al—N, Al—O, B—O, Si—N, Si—O, Si—C, or any combination thereof.

According to some embodiments, the cooling filler includes B—N and/or Al—N.

According to some embodiments, the cooling filler has a structural form of flakes, balls, platelets, agglomerates, disks, powder, or any combination thereof.

According to some embodiments, the cooling filler is characterized by an anisotropic or an isotropic thermal conductivity.

According to some embodiments, the isotropic thermal conductivity and/or the anisotropic in-plane thermal conductivity is at least about 170 W/m·K.

According to some embodiments, the electric field relaxer is selected from the group consisting of carbon powder, carbon fiber, carbon nanotubes, stainless steel fiber, polymer, graphene nanotubes, graphite, graphene powder, metallic powders, metal flakes, metal-coated fibers, metal nanowires, coated derivatives thereof, doped derivatives, and any combination thereof.

According to some embodiments, the metal includes silver, gold, copper, platinum, nickel, oxide derivative thereof, carbonaceous thereof, or any combination thereof.

There is provided herein, in accordance with some embodiments, an electronic assembly including a plurality of electronic components and the potting material disclosed herein, wherein the assembly is configured to operate at a voltage of at least about 3-300 kV.

According to some embodiments, the assembly is a transformer, a power supply, a modulator, or an inverter.

There is provided herein, in accordance with some embodiments, a method for producing a potted electronic assembly, the method including: providing a component A of an elastomer; adding an electric field relaxer and/or a cooling filler; mixing said elastomer with the electric field relaxer and/or the cooling filler to obtain a first mixer; admixing a component B of the elastomer into the first mixture to obtain a second mixture; and degassing the second mixture to obtain the potting material in a pre-polymerized form; providing a box comprising the electronic assembly; dispensing the pre-polymerized potting material into the box under vacuum; degassing the pre-polymerized potting material; and curing the pre-polymerized potting material within the electronic assembly; thereby obtaining the potted electronic assembly.

Certain embodiments of the present disclosure may include some, all, or none of the above advantages. One or more technical advantages may be readily apparent to those skilled in the art from the figures, descriptions and claims included herein. Moreover, while specific advantages have been enumerated above, various embodiments may include all, some or none of the enumerated advantages.

In addition to the exemplary aspects and embodiments described above, further aspects and embodiments will become apparent by reference to the figures and by study of the following detailed descriptions.

### BRIEF DESCRIPTION OF THE DRAWINGS

The invention will now be described in relation to certain examples and embodiments with reference to the following illustrative figures.

FIG. 1 is an exemplary flowchart of a method for producing potting material, according to some embodiments; and

FIG. 2 is an exemplary flowchart of a method for producing potted electronic assembly, according to some embodiments.

### DETAILED DESCRIPTION OF THE INVENTION

The detailed disclosure presents a potting material for high-voltage (HV) devices that addresses the unique challenges associated with them. The material is designed to possess high effective dielectric strength, high thermal conductivity, high adhesion, and low specific weight. These desirable properties are achieved altogether by utilizing a complementary combination of an elastomer, an electric field relaxer, and/or a cooling filler.

The elastomer material has excellent adhesiveness and a low glass transition temperature (Tg). These properties help maintain the required insulation, which in turn reduces the unwanted partial discharges. Additionally, by selecting a suitable cooling filler type in the right amount, the thermal conductivity can be adjusted. This feature is crucial to prevent overheating during high-voltage operation while keeping the specific weight low enough for easy handling. Lastly, adding a small amount of an electric field relaxer enables tuning of electrical resistance without compromising any of the desirable properties mentioned above.

In addition, the disclosure provides a method of producing a potted electronic assembly using the disclosed potting material.

There provided herein, in accordance with some embodiments, an insulating potting material for protecting electronic components in a high-voltage (HV) device, the potting material includes: an elastomer in a concentration of about 50-100% (w/w), a cooling filler in a concentration of about 5-70% (w/w), and/or an electric field relaxer in a concentration of about 0.005-0.2% (w/w); advantageously, it has been found that said potting material is characterized by an effective dielectric strength of at least about 80% of its theoretical dielectric strength, for example, at least about 85%, at least about 90%, at least about 95%, or preferably at least about 99%. Each possibility is a separate embodiment. According to some embodiments, the highly effective dielectric strength, advantageously, enables the utilization of the potential theoretical dielectric strength of the potting material, thereby introducing sufficient insulation for an HV device.

According to some embodiments, the potting material is characterized by an effective dielectric strength of at least about 100% of its theoretical dielectric strength, for example, at least about 110%, at least about 120%, at least about 130%, at least about 140%, at least about 150%, at least about 160%. Each possibility is a separate embodiment.

Surprisingly, and according to some embodiments, the effective dielectric strength of the potting material is about 300-600 V/mil, for example, about 350-400 V/mil, about 400-450 V/mil, about 450-500 V/mil, about 500-550 V/mil, or about 550-600 V/mil. Each possibility is a separate embodiment.

According to some embodiments, the potting material adheres well enough to the electronic components to minimize cracks and thus prevent partial discharge (PD). According to some embodiments, the potting material coheres well enough to the whole formulated potting material to minimize cracks and thus prevent PD.

Advantageously, and according to some embodiments, the PD is less than about 10 mV, for example, less than about 8 mV, less than about 5 mV, less than about 3 mV, or preferably eliminated. According to some embodiments, the PD occurs at a frequency of less than about 10 events over 2 min of 4 kV dc applied voltage, for example, at less than about 10-7 events, less than about 5-7 events, less than about 3-5 events, less than about 1-3 events, or preferably no PD events occur at all over 2 min of 4 kV dc applied voltage. Each possibility is a separate embodiment. According to some embodiments, the PD occurs at a frequency of less than about 20 events over 2 min of 2-100 kV de applied voltage, for example, at less than about 10 events, less than about 5-7 events, less than about 3-5 events, less than about 1-3 events, or preferably no PD events occur at all over 2 min of 2-10 kV de applied voltage. Each possibility is a separate embodiment. According to some embodiments, the PD occurs at a frequency of less than about 20 events over 2 min of 100-350 kV dc applied voltage, for example, at less than about 10 events, less than about 5-7 events, less than about 3-5 events, less than about 1-3 events, or preferably no PD events occur at all over 2 min of 100-350 kV dc applied voltage. Each possibility is a separate embodiment. According to some embodiments, the low, if any, PD increases the reliability of the potting material, while allowing the maximal utilization of the theoretical dielectric strength of the potting material.

According to some embodiments, the elastomer is in a concentration of about 90% (w/w), the cooling filler is in a concentration of about 10% (w/w), and/or the electric field relaxer is in a concentration of about 0.005-0.2% (w/w). According to some embodiments, the elastomer is in a concentration of about 80% (w/w), the cooling filler is in a concentration of about 20% (w/w), and/or the electric field relaxer is in a concentration of about 0.005-0.2% (w/w). According to some embodiments, the elastomer is in a concentration of about 70% (w/w), the cooling filler is in a concentration of about 30% (w/w), and/or the electric field relaxer is in a concentration of about 0.005-0.2% (w/w). According to some embodiments, the elastomer is in a concentration of about 60% (w/w), the cooling filler is in a concentration of about 40% (w/w), and/or the electric field relaxer is in a concentration of about 0.005-0.2% (w/w). According to some embodiments, the elastomer is in a concentration of about 50% (w/w), the cooling filler is in a concentration of about 50% (w/w), and/or the electric field relaxer is in a concentration of about 0.005-0.2% (w/w). Each possibility is a separate embodiment.

According to some embodiments, the potting material includes about 50-95% (w/w) of urethane-based elastomer, about 10-50% (w/w) of B—N cooling filler, and about 1-10% (w/w) of Al—O cooling filler. According to some embodiments, the potting material includes about 60-70% (w/w) of urethane-based elastomer, about 30-40% (w/w) of B—N cooling filler and/or of Al—O cooling filler. According to some embodiments, the potting material includes about 70-80% of urethane-based elastomer, about 20-30% (w/w) of B—N cooling filler and/or of Al—O cooling filler. According to some embodiments, the potting material includes about 80-90% (w/w) of urethane-based elastomer, about 10-20% (w/w) of B—N cooling filler and/or of Al—O cooling filler. Each possibility is a separate embodiment.

According to some embodiments, the potting material includes about 50-95% (w/w) of siloxane-based elastomer, about 10-50% (w/w) of B—N cooling filler, about 1-10% (w/w) of Al—N cooling filler, and about 0.005-0.2% graphene nanotubes concentrate. According to some embodiments, the potting material includes about 60-70% (w/w) of siloxane-based elastomer, about 30-40% (w/w) of B—N cooling filler and/or of Al—N cooling filler, and about 0.005-0.2% (w/w) graphene nanotubes concentrate. According to some embodiments, the potting material includes about 70-80% (w/w) of siloxane-based elastomer, about 20-30% (w/w) of B—N cooling filler and/or of Al—N cooling filler, and about 0.005-0.2% (w/w) graphene nanotubes concentrate. According to some embodiments, the potting material includes about 80-90% (w/w) of siloxane-based elastomer, about 10-20% (w/w) of B—N cooling filler and/or of Al—N cooling filler, and about 0.005-0.2% (w/w) graphene nanotubes concentrate. Each possibility is a separate embodiment.

According to some embodiments, the potting material includes about 50-95% (w/w) of epoxy-based elastomer, about 10-50% (w/w) of B—N cooling filler, about 1-10% (w/w) of Si—N cooling filler, and about 0.005-0.2% (w/w) graphite concentrate. According to some embodiments, the potting material includes about 60-70% (w/w) of epoxy-based elastomer, about 30-40% (w/w) of B—N cooling filler and/or of Si—N cooling filler, and about 0.005-0.2% (w/w) graphite concentrate. According to some embodiments, the potting material includes about 70-80% (w/w) of epoxy-based elastomer, about 20-30% (w/w) of B—N cooling filler and/or of Si—N cooling filler, and about 0.005-0.2% (w/w) graphite concentrate. According to some embodiments, the potting material includes about 80-90% (w/w) of epoxy-based elastomer, about 10-20% (w/w) of B—N cooling filler and/or of Si—N cooling filler, and about 0.005-0.2% (w/w) graphite concentrate. Each possibility is a separate embodiment.

According to some embodiments, the potting material includes about 50-99.9% (w/w) of epoxy-based elastomer and about 0.005-0.2% (w/w) graphite or graphene nanotube concentrate.

According to some embodiments, the potting material includes about 50-99.9% (w/w) of siloxane-based elastomer and about 0.005-0.2% (w/w) graphite or graphene nanotube concentrate.

According to some embodiments, the potting material includes about 50-100% (w/w) of siloxane-based elastomer.

According to some embodiments, the potting material includes about 50-100% (w/w) of polydimethylsiloxane.

According to some embodiments, the potting material includes about 50-100% (w/w) of polyurethane.

According to some embodiments, the potting material includes about 50-100% (w/w) of epoxy polymer.

According to some embodiments, the potting material is characterized by a thermal conductivity of at least about 0.2-3 W/m·k, for example, at least about 0.2-1 W/m·k, at least about 1-2 W/m·k, or at least about 2-3 W/m·k. Each possibility is a separate embodiment. Advantageously, according to some embodiments, the high conductivity protects the electronic components from over-heating.

According to some embodiments, the potting material exhibits a specific weight of about 0.8-2.0 gr/cm³, for example, about 0.8-1 gr/cm³, about 1-1.2 gr/cm³, about 1.2-1.5 gr/cm³, or about 1.5-2.0 gr/cm³. Each possibility is a separate embodiment. According to some embodiments, the lightweight potting material advantageously facilitates the handling of the potting material and potted assembly.

According to some embodiments, the potting material is characterized by a glass transition temperature (Tg) of about (−170)-(+170)° C., for example, about (−170)-(−120)° C., about (−120)-(−80)° C., about (−80)-(−20)° C., about (−20)-(+50)° C., about (+50)-(+120)° C., about or (+120)-(+170)° C. Each possibility is a separate embodiment. According to some embodiments, this characteristic glass transition temperature prevents brittleness, adheres better, and lowers the hardness of the potting material at the working temperature range.

According to some embodiments, the hardness of the potting material is less than about 80 according to shore 00, and less than about 50 according to shore A. According to some embodiments, the relatively low Tg and low hardness, thereby, allow the HV operation with minimum adhesive failure, minimum electrical discharges, and minimum mechanical vibration.

According to some embodiments, the elastomer is selected from but not limited to phenol-formaldehyde polymer, epoxy resins, polyisoprene, butadiene polymer, styrene-butadiene copolymers, ethylenepropylene rubber (specifically EPDM), butyl and halobutyl elastomers, polyurethanes, polysiloxanes, polychloroprenes, nitrile rubber, polyacrylic rubbers, fluorocarbon elastomers, or any combination thereof. Each possibility is a separate embodiment.

According to some embodiments, the elastomer is polydimethylsiloxane (PDSM).

According to some embodiments, the elastomer is characterized by a dielectric strength of about 400-600 V/mil, for example, about 400-450 V/mil, about 450-500 V/mil, about 500-550 V/mil, or about 550-600 V/mil. Each possibility is a separate embodiment.

According to some embodiments, an elastomer specific weight is about 0.8-2.0 gr/cm³, for example, about 0.8-1.2 gr/cm3, about 1.2-1.6 gr/cm3, or about 1.6-2.0 gr/cm³. Each possibility is a separate embodiment.

According to some embodiments, the elastomer is polymerized from one or two pre-polymer parts. According to some embodiments, the parts are in a physical state of liquid, solid, and/or semi-solid gel.

According to some embodiments, at least one of the pre-polymer one or two parts is characterized by a viscosity of about 300-3000 cP, for example, about 300-500 cP, about 900-1300 cP, about 1300-1700 cP, about 1700-2000 cP, about 2000-3000 cP, or preferably about 500-900 cP. Each possibility is a separate embodiment. According to some embodiments, the low viscosity prevents the formation of bubbles. According to some embodiments, the low viscosity facilitates the processing during the production of a potted assembly and prevents PD events during HV operation.

According to some embodiments, the pre-polymer one or two parts are selected from but not limited to a monomer, a crosslinker, a polymer, a pre-polymer, a pre-preg, a catalyst, a solvent, or any combination thereof. Each possibility is a separate embodiment.

According to some embodiments, the elastomer is characterized by a thermal conductivity of at least about 0.1 W/m·K, for example, at least about 0.5-1.0 W/m·K, at least about 1.0-1.5 W/m·K, at least about 1.5-2 W/m·K, or preferably about 0.1-0.5 W/m·K. Each possibility is a separate embodiment.

According to some embodiments, the cooling filler includes but is not limited to B—N, Al—N, Al—O, B—O, Si—N, Si—O, Si—C, or any combination thereof. Each possibility is a separate embodiment. According to some embodiments, the cooling filler includes preferably B—N and/or Al—N.

According to some embodiments, the cooling filler has a structural form selected from but not limited to flakes, balls, platelets, agglomerates, disks, powder, or any combination thereof. Each possibility is a separate embodiment.

According to some embodiments, the cooling filler is characterized by anisotropic or isotropic thermal conductivity.

According to some embodiments, an in-plane conductivity of the anisotropic thermal conductivity is about an order of magnitude higher as compared to a thru-plane thermal conductivity of the anisotropic conductivity. According to some embodiments, the high in-plane thermal conductivity increases the effectiveness of the cooling filler per given amount thereof. According to some embodiments, the high effectiveness of the in-plane anisotropic cooling filler requires less amount of cooling filler to be incorporated in the potting material, compared to the isotropic one. According to some embodiments, lowering the amount of the cooling filler decreases the specific weight of the potting material.

According to some embodiments, the isotropic thermal conductivity and/or the anisotropic in-plane thermal conductivity is at least about 170 W/m·K, for example, at least about 170-250 W/m·K, at least about 250-350 W/m·K, at least about 350-450 W/m·K, at least about 450-550 W/m·K, at least about 550-650 W/m·K, or at least about 650-750 W/m·K. Each possibility is a separate embodiment.

According to some embodiments, the cooling filler is characterized by a specific weight of about 0.2-1.1 gr/cm³, for example, about 0.2-0.4 gr/cm³, about 0.4-0.6 gr/cm³, about 0.6-0.8 gr/cm³, or about 0.8-1.1 gr/cm³. Each possibility is a separate embodiment.

According to some embodiments, the cooling filler is characterized by dielectric strength of about 300-1800 V/mil, for example, about 300-500 V/mil, about 500-700 V/mil, about 700-900 V/mil, about 900-1100 V/mil, about 1100-1300 V/mil, about 1300-1500 V/mil, or about 1500-1800 V/mil.

According to some embodiments, the electric field relaxer is selected from but not limited to carbon powder, carbon fiber, carbon nanotubes, stainless steel fiber, polymer, graphene nanotubes, graphite, graphene powder, metallic powders, metal flakes, metal-coated fibers, metal nanowires, coated derivatives thereof, doped derivatives, and any combination thereof. Each possibility is a separate embodiment. According to some embodiments, the metal of the electric field relaxer is selected from but not limited to silver, gold, copper, platinum, nickel, oxide derivative thereof, carbonaceous thereof, or any combination thereof.

According to some embodiments, the electric field relaxer is graphene nanotubes.

According to some embodiments, a low concentration of electric field relaxer enables the electrical resistivity of the potting material to be reduced and fine-tuned while retaining a minimal impact on the properties of the potting material.

According to some embodiments, the electric field relaxer may lower the volume resistivity of the potting material from about 1015 to 101 Ω·cm, preferably from about 1015 to 1007 Ω·cm. For example, the volume resistivity may be lowered to about 1015-1013 Ω·cm, about 1013-1011 Ω·cm, about 1011-1009 Ω·cm, about 1011-1009 Ω·cm, about or 1009-1007 Ω·cm. Each possibility is a separate embodiment. According to some embodiments, the electric field relaxer reduces electrical leakage, thus preventing partial discharges and allowing high-voltage operation with minimum failures.

There provided herein, in accordance with some embodiments, an assembly of electronic components including the potting material disclosed herein, the assembly is configured to operate at a medium and high voltage. According to some embodiments, the assembly is configured to operate at a voltage of about 2-350 kV, for example, the assembly is configured to operate at a voltage of about 2-10 kV, about 10-30 kV, about 30-50 kV, about 50-100 kV, about 100-200 kV, or about 200-350 kV. Each possibility is a separate embodiment.

According to some embodiments, the assembly of electronic components is capable of operating at high voltage for a period of at least about 5 h, at least about 10 h, at least about one day, at least about one month, or at least to about 1 year. Each possibility is a separate embodiment. According to some embodiments, the assembly of electronic components is capable of operating at high voltage for a period of at least about 5 h- to about 1 h, at least about 5-10 h, at least about one day- to, at least about one month, or at least to about 1 month to about 1 year. Each possibility is a separate embodiment.

According to some embodiments, the assembly is selected from, but not limited to, a transformer, a power supply, a modulator, and an inverter. Each possibility is a separate embodiment.

There provided herein, in accordance with some embodiments, a method for producing a potting material, the method includes: providing component A of an elastomer; adding an electric field relaxer and/or a cooling filler; mixing said elastomer with the electric field relaxer and/or a cooling filler to obtain a first mixture; admixing component B of the elastomer into the first mixture to obtain a second mixture; and degassing the second mixture to obtain a potting material in a pre-polymerized form. According to some embodiments, a degassing step is further added to the obtained first mixture.

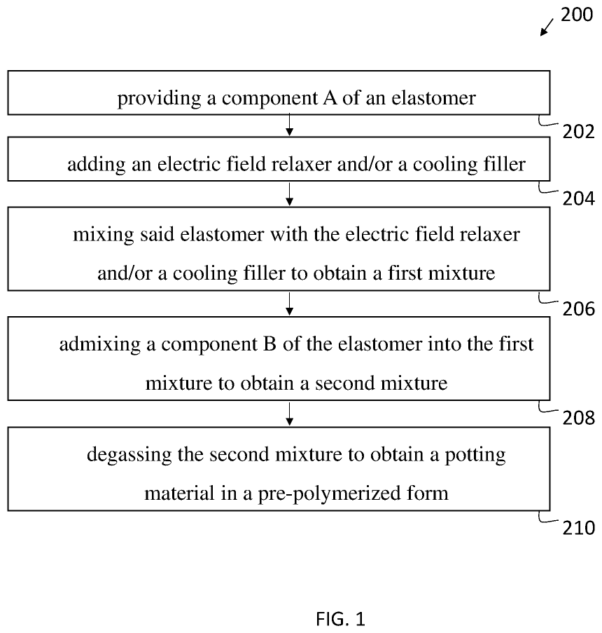

Reference is now made to FIG. 1, which schematically illustrates a flowchart 200 describing the method for producing a potting material. In step 202 component A of an elastomer is provided. In step 204 an electric field relaxer and/or cooling filler is added. In step 206 the said elastomer, electric field relaxer, and/or cooling filler are mixed to obtain a first mixture. In step 208 component B of the elastomer is admixed into the first mixture to obtain a second mixture. In step 210 the second mixture is degassed to obtain a potting material in a pre-polymerized form.

According to some embodiments, the mixing of said elastomer with the electric field relaxer and/or a cooling filler to obtain a first mixture includes stirring at a rate of about 300-3000 rpm, for example, at about 300-800 rpm, about 800-1500 rpm, about 1500-2600 rpm, or about 2600-3000 rpm. Each possibility is a separate embodiment.

According to some embodiments, the admixing component B of the elastomer into the first mixture to obtain a second mixture includes stirring at a rate of about 100-2000 rpm, for example, at about 100-800 rpm, about 800-1400 rpm, or about 1400-2000 rpm. Each possibility is a separate embodiment.

There is provided herein, in accordance with some embodiments, a method for producing a potted electronic assembly, the method includes: providing a box comprising the electronic assembly; dispensing the pre-polymerized potting material disclosed herein into the box under vacuum; degassing the potting material; and curing the potting material within the electronic assembly; thereby obtaining the potted electronic assembly.

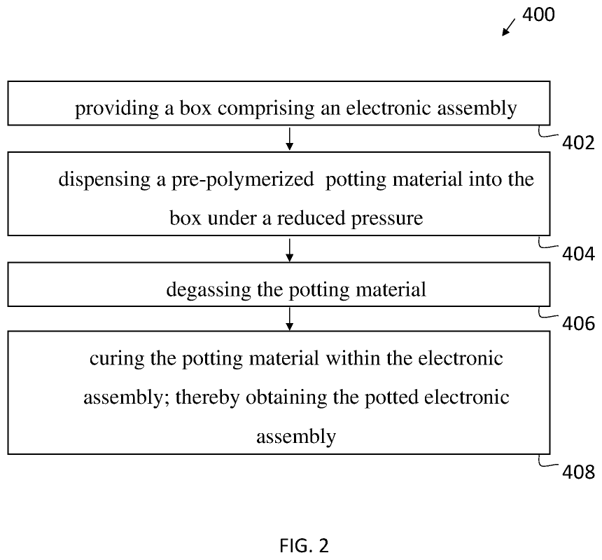

Reference is now made to FIG. 2, which schematically illustrates a flowchart 400 describing the method for producing a potted electronic assembly. In step 402 a box comprising an electronic assembly is provided. In step 404 the pre-polymerized potting material is dispensed into the box under vacuum. In step 406 the potting material is degassed. In step 408 the potting material within the electronic assembly is cured, thereby obtaining the potted electronic assembly.

According to some embodiments, the curing time is less than about 72 h, for example, less than about 72-48 h, less than about 48-32 h, less than about 32-24 h, or preferably less than about 24 h. Each possibility is a separate embodiment.

There is provided herein, in accordance with some embodiments, an assembly of electronic components comprising the potting material disclosed herein.

Unless defined otherwise, all technical and scientific terms used herein have the same meaning as is commonly understood by one of skill in the art to which this subject matter pertains. The following definitions are provided for clarity.

The term “a” or “an” as used herein includes the singular and the plural, unless specifically stated otherwise. Therefore, the terms “a,” “an,” or “at least one” can be used interchangeably in this application.

As used herein, the verb “comprise” as is used in this description and in the claims and its conjugations are used in its non-limiting sense to mean that items following the word are included, but items not specifically mentioned are not excluded.

As used herein, the term “about” when used in connection with a numerical value includes ±10% from the indicated value. In addition, all ranges directed to the same component or property herein are inclusive of the endpoints, are independently combinable, and include all intermediate points and ranges. It is understood that where a parameter range is provided, all integers within that range, and tenths thereof, are also provided by the invention.

As used herein, according to some embodiments, the term “potting material” refers to a material used for filling a complete electronic assembly with a solid or gelatinous compound. The main applications are for high-voltage assemblies by excluding gaseous phenomena such as corona discharge, insulation, resistance to shock and vibration, and for the exclusion of water, moisture, or corrosive agents.

As used herein, according to some embodiments, the term “elastomer” refers to a material characterized by its deformability with essentially complete recoverability. In order for a material to exhibit this type of elasticity, three molecular requirements are to be met: (1) the material includes polymeric chains, (2) the chains have a high degree of flexibility and mobility, and (3) the chains are joined into a network structure.

As used herein, according to some embodiments, the term “cooling filler” refers to a component that increases the thermal conductivity of the potting material.

As used herein, according to some embodiments, the term “electric field relaxer” refers to an electrically conductive component capable of adjusting the volume resistivity of the potting material. Its concentration, which is denoted as w/w, according to some embodiments, refers to the relative weight of a concentrate thereof, which includes the electric field relaxer and a carrier.

As used herein, according to some embodiment, the term “volume resistivity” is the ratio of DC voltage per unit thickness to the amount of current per unit area passing through a material. Volume resistivity is usually expressed in units of [ohm-cm].

As used herein the term “high voltage” refers to a voltage of about 100-350 kV.

As used herein the term “medium voltage” refers to a voltage of about 2-100 kV.

As used herein, according to some embodiment, the term “pre-polymer parts” refers to components used to create the polymer.

As used herein, according to some embodiment, the term “pre-polymerized form” refers to a form of a potting material mixture comprising polymer parts prior to polymerization.

In the herein provided description, various aspects of the disclosure were described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

The following examples are presented in order to more fully illustrate some embodiments of the invention. They should, in no way be construed, however, as limiting the broad scope of the invention. One skilled in the art can readily devise many variations and modifications of the principles disclosed herein without departing from the scope of the invention.

### EXAMPLES

### Example 1—Producing a Potting Material

A mixing container with an 11 cm diameter and a total volume of 1.5 L was positioned inside a larger cooling container filled up with water at about 10° C. An amount of 199 gr part A of a siloxane-based elastomer was slowly added into the mixing container. An amount of 2 gr graphene nanotube concentrate was then added into the mixing container followed by stirring for 15 min at 1600 rpm. The impeller was positioned at half the height of the liquid level. The mixture was then degassed until no bubbles were observed. After the mixture was inspected by a microscope to ensure its transparency, an amount of 199 gr part B of the siloxane-based elastomer was added. The mixture was further stirred for 10 min at 1600 rpm. From this point forward, all additional steps should be carried out within 30-60 min before the curing step starts. The mixture was then transferred into a vacuum chamber, and an evacuation to a pressure of about 1 Torr was then applied for 2 min followed by re-ventilation to an atmospheric pressure. The evacuation and ventilation steps were repeated twice to remove all bubbles from the container and pipes.

### Example 2—Producing a Potting Material

A mixing container with an 11 cm diameter and a total volume of 1.5 L was positioned inside a larger cooling container filled up with water at about 10° C. An amount of 100 gr part A of a siloxane-based elastomer was slowly added into the mixing container. An amount of 40 gr cooling filler was then added into the mixing container followed by stirring for 5 min at 200 rpm. The impeller was positioned at half the height of the liquid level. The mixture was then degassed until no bubbles were observed. After the mixture was inspected by a microscope to ensure its transparency, an amount of 100 gr part B of the siloxane-based elastomer was added. The mixture was further stirred for 5 min at 200 rpm. From this point forward, all additional steps should be carried out within 30-60 min before the curing step starts. The mixture was then transferred into a vacuum chamber, and an evacuation to a pressure of about 1 Torr was then applied for 2 min followed by re-ventilation to an atmospheric pressure. The evacuation and ventilation steps were repeated twice to remove all bubbles from the container and pipes.

### Example 3—Producing a Potted Electronic Assembly

A box with a well-connected electronic assembly was positioned in a vacuum chamber. The box, equipped with a funnel, was tilted by 10 degrees, positioning the dispensing inlet lifted upwards, and the vacuum chamber was evacuated to a reduced pressure of 1 Torr. A mixture of the pre-polymerized potting material was then dispensed through the inlet. The chamber was evacuated down to 1 Torr for 2 min until all bobbles were removed followed by ventilation for 2 min. Two additional cycles of evacuation and ventilation were performed, and finally, the potted box was left to cure under ventilation for about 24 h until the potting material was completely dry.

### Example 4—Testing of Partial Discharge

A partial discharge assessment was performed on a potting material including parts A and B, by using an HVNS module in a SHVM BP5 cage. A DC voltage of 4 kV was applied for 2 min and measurements were carried out by a PD detector. As seen in Table 1, three out of four measurement cycles resulted in PD events and one measurement did not result in any PD events. The maximum peak values were observed at the voltage of about 2.3-2.8 mV.

TABLE 1

| Test# | 1 | 2 | 3 | 4 |
|---|---|---|---|---|
| PD events | 2 | 0 | 2 | 3 |
| Max Peak, mV | 2.3 | 0 | 2.8 | 2.7 |

### Example 5—Testing of Partial Discharge

A construction was built with a 1 mm distance between electrodes and was potted with a potting material having a theoretical dielectric strength of 470 V/mil. This dielectric strength should hold in theory a voltage of 19 kV without experiencing PD events. In this example, a voltage of 30 kV was applied to the electrodes and a PD detector was connected for more than 2 hours. Advantageously, no PD events or dielectric failure were detected during the test, indicating that the effective dielectric strength reached 750 V/mil, which is 160% more than the expected theoretical dielectric strength value. Hence the dielectric strength was fully employed in this case and even exceeded 100% under the current experimental conditions (i.e. time, voltage, etc.).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While certain embodiments of the invention have been illustrated and described, it will be clear that the invention is not limited to the embodiments described herein. Numerous modifications, changes, variations, substitutions and equivalents will be apparent to those skilled in the art without departing from the spirit and scope of the present invention as described by the claims, which follow.

What is claimed is:

1. An insulating potting material for protecting electronic components in a high-voltage (HV) device, the potting material comprising;
an elastomer in a concentration of 50-100% (w/w);
a cooling filler in a concentration of 5-70% (w/w); and/or
an electric field relaxer in a concentration of 0.005-0.2% (w/w),
wherein said potting material is characterized by an effective dielectric strength of at least about 80% of its theoretical dielectric strength.

2. The potting material of claim 1, wherein the partial discharge (PD) is less than about 10 mV, at a frequency of less than about 10 events over 2 min of 4 kV dc applied voltage.

3. The potting material of claim 1, wherein the potting material is characterized by a thermal conductivity of at least about 0.2-3 W/m·k.

4. The potting material of claim 1, wherein the potting material exhibits a specific weight of less than about 0.8-2.0 gr/cm³.

5. The potting material of claim 1, wherein the elastomer comprises phenol-formaldehyde polymer, epoxy resins, polyisoprene, butadiene polymer, styrene-butadiene copolymers, ethylenepropylene rubber (specifically EPDM), butyl and halobutyl elastomers, polyurethanes, polysiloxanes, polychloroprenes, nitrile rubber, polyacrylic rubbers, fluorocarbon elastomers, or any combination thereof.

6. The potting material of claim 5, wherein the elastomer is polydimethylsiloxane (PDMS).

7. The potting material of claim 1, wherein the elastomer is characterized by a dielectric strength of about 400-600 V/mil.

8. The potting material of claim 1, wherein the elastomer originates from at least two pre-polymer parts each having a physical state of liquid and/or semi-solid gel.

9. The potting material of claim 8, wherein at least one of the at least two pre-polymer parts is characterized by a viscosity of about 300-4000 cP.

10. The potting material of claim 8, wherein the at least two parts comprise monomer, crosslinker, polymer, pre-polymer, pre-preg, catalyst, solvent, or any combination thereof.

11. The potting material of claim 1, wherein the elastomer is characterized by a thermal conductivity of at least about 0.1 W/m·K.

12. The potting material of claim 1, wherein the cooling filler comprises B—N, Al—N, Al—O, B—O, Si—N, Si—O, Si—C, or any combination thereof.

13. The potting material of claim 1, wherein the cooling filler comprises B—N and/or Al—N.

14. The potting material of claim 1, wherein the cooling filler has a structural form of flakes, balls, platelets, agglomerates, disks, powder, or any combination thereof.

15. The potting material of claim 1, wherein the cooling filler is characterized by an anisotropic or an isotropic thermal conductivity, and wherein the isotropic thermal conductivity and/or the anisotropic in-plane thermal conductivity is at least about 170 W/m·K.

16. The potting material of claim 1, wherein the electric field relaxer is selected from the group consisting of carbon powder, carbon fiber, carbon nanotubes, stainless steel fiber, polymer, graphene nanotubes, graphite, graphene powder, metallic powders, metal flakes, metal-coated fibers, metal nanowires, coated derivatives thereof, doped derivatives, and any combination thereof.

17. The potting material of claim 16, wherein the metal comprises silver, gold, copper, platinum, nickel, oxide derivative thereof, carbonaceous thereof, or any combination thereof.

18. An electronic assembly comprising a plurality of electronic components and the potting material of claim 1, wherein the assembly is configured to operate at a voltage of at least about 3-300 kV.

19. The assembly of claim 18, wherein the assembly is a transformer, a power supply, a modulator, or an inverter.

20. A method for producing a potted electronic assembly, the method comprising;
providing a component A of an elastomer;
adding an electric field relaxer and/or a cooling filler;
mixing said elastomer with the electric field relaxer and/or the cooling filler to obtain a first mixture;
admixing a component B of the elastomer into the first mixture to obtain a second mixture; and
degassing the second mixture to obtain the potting material in a pre-polymerized form;
providing a box comprising the electronic assembly;
dispensing the pre-polymerized potting material into the box under vacuum;
degassing the pre-polymerized potting material; and
curing the pre-polymerized potting material within the electronic assembly; thereby obtaining the potted electronic assembly.
